(19) United States
(12) Patent Application Publication
(10) Pub. No.: US 2008/0110469 A1
(43) Pub. Date: May 15, 2008

(54) Strapless flexible tribo-charged respiratory facial mask and method

(76) Inventor: Stanley Weinberg, Los Angeles, CA (US)

Correspondence Address: Snell & Wilmer L.L.P., Suite 1400, 600 Anton Boulevard, Costa Mesa, CA, 92626, US

(21) Appl. No.: 11/598,321

(22) Filed: Nov. 13, 2006

(51) Int. Cl. A62B 18/08; A62B 23/00

(52) U.S. Cl. 128/863; 128/206.25

(57) ABSTRACT

A facial mask for filtering ambient air is formed from a pre-form of a multilayer flexible flat filter member of a size to extend over the mouth and nostrils of the user. The flat pre-form filter member can have an ovoid perimeter with an endless band of a hypoallergenic adhesive tape encircling a perimeter of the filter member and operable for sealing with the user's skin to prevent leakage over extended use. Portions of the adhesive tape can self-seal during a sizing step to form structural paths for maintaining a central concavity to ensure a large filtration area offset from the nostrils and mouth of the user. The flexible filter material can further include an activated carbon layer.

### BACKGROUND OF THE INVENTION

1. Field of the Invention

The present invention is directed to a respiratory electrostatic facial mask and more particularly, to an improved configuration of a facial mask that can be subjectively configured by the user to seal on the user's face to prevent leakage while still maintaining a large filter area and a method of sizing a pre-form flat flexible filter member to subsequently provide a facial mask.

2. Description of Related Art

Respirator products such as facial masks are frequently used as a tool to protect workers in industrial environments, medical personnel and the general public against contaminants that are airborne, including organic and non-organic airborne particles and various diseases such as viruses and bacteria that can be carried as airborne particles. The National Institute for Occupational Safety and Health (NIOSH) has proposed various procedures for certifying respirator products in correlation with the Center for Disease Control and Prevention. Frequently there is a recommendation for training to ensure that the user of such a mask have adequate knowledge on how to properly employ such devices. NIOSH Federal Respiratory Regulations 42 CFR Part 84 is the standard used for industrial applications.

A representative or surrogate mask is designated and tested in occupational settings as acceptable for a category of users. However, the use of surrogate masks can be time consuming and expensive and does not guarantee that the size selection for actual masks will replicate the exact same fit and protection on the subject actually tested.

Quantitative respiratory fit testing is frequently proposed with an emphasis to try and eliminate any leakage in an interface between the user's face and the mask. No matter how effective the filter material is in stopping airborne particles, any leak about the edges of the facial mask can negate the advantages of the filter material. Frequently, respiratory masks are maintained on a user's face with a resilient cord or cords and the mask can have a pre-formed conical configuration to extend over the nose and mouth of the user. See U.S. Pat. No. 5,357,947. Such respiratory facial masks can frequently qualify for an N95 rating which defines the penetration of particles through the filter material only. Leakage, however, around the mask can negate the value of such a mask to the user and belie the N95 rating effect. Masks may also use a bendable wire metal nose strip to adjust for contours of the face such as the nose.

The prior art also has proposed providing sealing flaps with a pressure sensitive adhesive to a face engaging side of a facial mask in a medical environment, such as disclosed in U.S. Pat. No. 3,357,426. Other examples of a strapless respiratory facial mask that can be customized to the contours of a wearer's face can be seen in U.S. Pat. No. 5,918,598 and U.S. Pat. No. 6,196,223.

There is still a need in this field of respirator facial mask filters to provide a highly effective respiratory mask that can be easily donned and used by an unskilled person to prevent leakage while maintaining a relatively comfortable fit and increasing the ability to prevent penetration into or out of the facial mask. Obviously, economics can bear an important component in order to effectively provide a facial mask that can assist the general population from potential airborne particulate matter including viruses and bacteria of 0.1 mkm particles (microns) at an appropriate pressure drop to provide a comfortable breathing resistance factor for the user. These goals must be obtained in an economical manner in order to make such a respirator facial mask available to the general population.

### SUMMARY OF THE INVENTION

The present invention provides a flat facial mask for filtering and purifying ambient air and includes a flexible filter member of a size to extend over the mouth and nostrils of a user to enable the user to breathe and talk through the facial mask in a comfortable manner for at least 8 hours. The filter member can include multiple layers, for example, of a tribo-charged mixed fiber arrangement to block airborne particles of 50 nm size while providing 25 mm or less of exhalation pressure resistance. A hypoallergenic adhesive can extend about the perimeter of the filter member and enable the user to self-seal the facial mask with the user's skin across the nose and mouth. The flexible filter member can be a non-woven fiber material of two electrically dissimilar synthetic polymers which are processed to create a charge transfer. An acrylic fiber can serve as an insulator to ensure a stable and permanent charge transfer.

Alternatively, an intermediate layer of a flexible activated carbon can be laminated between the first and second layers of the fiber material as an alternative embodiment.

The combination of the first and second layers can be approximately 0.125 inches thick while any additional activated carbon particles in a flexible carrier matrix can add approximately 0.05 inches to the thickness. The facial masks can be sold in a pre-form flat ovoid or a rectangular perimeter configuration. A plurality of pre-form facial masks can be packed in a stack arrangement for distribution and easy use by an unskilled user.

In a preferred embodiment, the respiratory facial mask can have a pre-form ovoid shape with a flat lateral length approximately twice the width to provide an approximately 200 cm² of filtration area. As supplied to the user, a medical grade adhesive such as a hypoallergenic acrylate adhesive band of tape extends approximately ⅝ in width endlessly about the perimeter of the ovoid. A tribo-charged filter media supports the adhesive tape and a releasable paper strip covers the adhesive with appropriate cuts or slits on either side of the length of the pre-form facial mask. The exterior surface of the facial mask has a very thin meltblown layer to provide a glossy surface on the exterior of the turbo-electrically charged polypropylene/acrylic filter media layer, plus it acts as a pre-filter to prevent loading of the bottom filter material layer.

Optionally, a film of an antimicrobial layer such as silver nano particles or silver ion zeolite can be sprayed on the glossy surface layer. As a further option, a thin intermediate layer of a carbon impregnated non-woven fiber can be included to treat the air flow.

A method of sizing the universal ovoid pre-form to a specific size and contour of face is provided. The user can take an initial pre-form thin flat flexible filter member and draw back the paper liners a short distance on opposite lateral sides, while leaving a major length of the paper liners in place. The user can pinch or tent the flexible fiber member while placing it over the bridge of the nose and the chin in order to fit and cover the nostrils and mouth of the user. By the pinching on the opposite sides, the exposed portions of adhesive will adhere and create support tabs or wings as it forms a central portion of the pre-form filter member into a concave facial mask configuration suitable for the particular user. When a user is comfortable that the filter member has now been subjectively customized to a concave filter configuration approximating the contours of the user's face, the user can then remove the remaining paper liner strips and firmly attach the respiratory facial mask in a sealing manner around the entire perimeter of adhesive to the face of the user. Additional pressing or pinching of the tabs or wings can assist in pulling the facial mask into full sealing contact with the user's face.

The tabs or wings now provide a structural support and integrity to the concave configuration, while still maintaining an effective utilization of the total filtration area. The selected adhesive material will actually increase its adhesive force to the face as it sets up and when it is time to remove the facial mask, the tabs can be grasped to assist in effectively peeling the spent respiratory facial mask from the face of the user. The use of a glossy exterior surface assists in preventing the accumulation of particles on the surface of the mask and can supply a support surface for an antimicrobial film layer.

Our facial mask can be provided in a pre-form flat configuration to assist in manufacturing and packaging of a plurality of stacked, flat facial respiratory masks. The ovoid configuration of the facial mask assists in providing a subjective fitting to seal the perimeter of the mask to the face of the user, while permitting it to flex to accommodate movements of the chin for talking and breathing. The increased filtration area lowers the resistance for both exhaling and inhaling by the user.

The user can easily create an appropriate facial mask with a customized size fit for the user and then sequentially seal it to the user's face.

Alternatively, the facial mask can be provided with preformed tabs to provide an approximate initial concavity that is subsequently further adjusted for subjective sizing and sealing to the user's face.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 is a schematic perspective view of a first embodiment of the facial mask of the present invention mounted on a user;

FIG. 2 is a rear view of the facial mask with paper liner strips partially removed from one side;

FIG. 3 is a partial schematic view disclosing a user's pressing of a lateral side to subjectively fit the mask by configuring it into a central concavity with tabs;

FIG. 4 is a rear elevated view of the facial mask preliminarily configured into a size for fitting on a user with the paper liners being removed;

FIG. 5 is a front view of the facial mask of FIG. 4; and

FIG. 6 is an exploded view of the facial mask of the first embodiment;

FIG. 7 is a perspective view of sizing a pre-form flat flexible mask on a user;

FIG. 8 is a perspective view of forming tabs to create a subjective concavity;

FIG. 9 is a perspective view of finalizing a customized facial mask;

FIG. 10 is a chart showing a salt load particle test of our invention;

FIG. 11 is a cross section of another embodiment modification; and

FIG. 12 is a schematic comparison of a conventional facial mask and the present mask.

### DETAILED DESCRIPTION OF THE PREFERRED EMBODIMENTS

Reference will now be made in detail to the preferred embodiments of the present invention which set forth the best modes contemplated to carry out the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the issued claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures and components have not been described in detail as not to unnecessarily obscure aspects of the present invention.

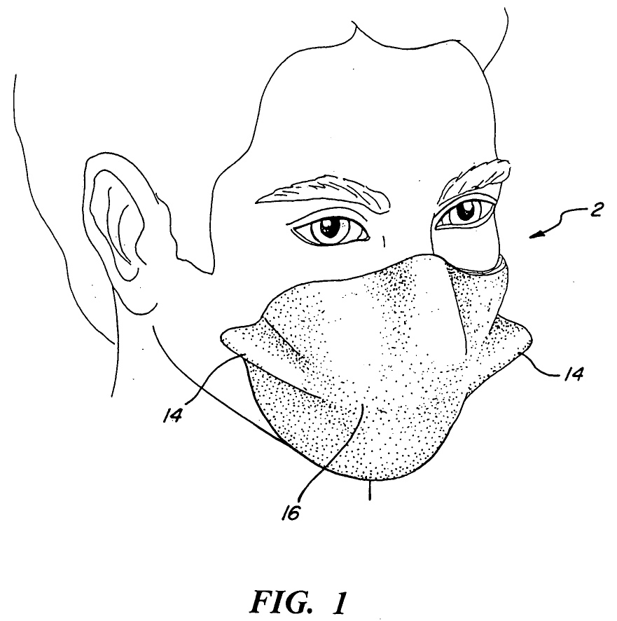

Referring to FIG. 1, a respiratory facial mask 2 of a strapless configuration is disclosed schematically mounted on a face of a user to prevent and lower the risk of inhalation and discharge of airborne particles of a size that would include live bacteria and viruses such as SARS and Avian influenza such as H5N1. The H5N1 viral particle is generally spherical in configuration and can be from 50 to 180 nanometers in aerodynamic size. Such particles can be aerosolized in water droplets and deposited on open surfaces or can become airborne by coughing or sneezing of the affected victim. Evaporation and low humidity can reduce the active viral particle to below 0.5 microns. As can be appreciated, it is not only important that the filtering material of the facial mask be able to prohibit both the inhalation and exhalation of such size particles, but that the mask be sealed to prevent any leakage between the interface of the person's skin and the mask.

The facial mask 2, shown in FIG. 1, has sufficient flexibility to permit an adaption to most face configurations of potential users. The active filtration surface area can be approximately 200 cm². This range permits coverage for not only a significant number of the population of users but provides a sufficient area to permit adequate levels of exhalation and inhalation pressure for the user.

As can be readily appreciated, in a toxic or infectious environment, additional protective measures should be undertaken including goggles and covering of the user's skin while ensuring that the disposal of such a mask be done with protective gear such as rubber gloves with an appropriate disposal receptacle for the potentially contaminated mask.

A medical grade adhesive tape that is conformable and can flexibly seal such as a hypoallergenic pressure sensitive acrylate adhesive tape is used to lock the filtration media of the facial mask to the user's face. An example of such a tape is the 3M Medical Nonwoven Tape #9917 sold by 3M Medical Specialties although other adhesive members can be used. The facial mask 2 is designed to meet the standards associated with a NIOSH style negative pressure respiratory facial mask of sm, N, R or P series.

Referring to FIG. 6, an exploded view of one embodiment of the facial mask 2, is disclosed as a pre-form with an ovoid shaped perimeter. A thin high fluff melt blown glossy surface layer 4 of approximately 0.05 inches in thickness and 42 g/m² can impede the accumulation of particles on the surface. An interior layer of a tribo-charged mixed fiber of a non-woven needled felt is disclosed as a second layer 6. The mixed fiber nonwoven needle felt can be composed of one layer of polypropylene/acrylic from Hollingworth & Vose Air Filtration Ltd sold as Technostat: 300 g/m². It is an electrostatically charged needle felt of two electrically dissimilar synthetic polymers which are processed to create a charge transfer between the two different types of coarse fibers with both positive and negative charges present on the fiber surfaces. As the acrylic fiber, in the blend, is an extremely effective insulator the charge transfer is stable and permanent. This can enhance filtration efficiency for viral sized particles. The construction yields very low breathing resistance and very low viral particle penetration even at high respiration rates. For instance, our preferred embodiment shows no more than 0.03% penetration rate of a 0.3 micron salt test particle at a flow rate of 85 L/min. with an exhalation resistance of approximately 11 mm (H₂O), making it eligible for a NIOSH N-100 certification and HEPA certification.

The thickness of the second layer 6 fiber media can be approximately 0.125 inches and the surface area can be in the range of 200 cm to provide an optimized available breathing area so that a low face velocity of transit particles and penetration effects can be minimized. The maximum pre-form length L can be 9 inches and the maximum pre-form width W can be 4.875 inches. An alternative smaller size can have an L dimension of 7 inches and a W dimension of 4.875 inches and can fit children and small size adults.

A hypoallergenic adhesive layer 8 is provided about the perimeter of the filter media and can be applied as a tape, approximately ⅝ inches wide, in an endless oval loop. A paper liner 10 with a two-sided differential silicon release can be mounted over the adhesive layer 8 to protect it prior to use. The adhesive layer 8 has a capacity of adhering to a test plate of stainless steel with a force of 27 ounces/inch width. This medical grade adhesion perimeter is highly moldable and conformable and can flow during pressure sensitization and setting into ultra tiny skin imperfections, contours and textures to form a face seal against pathogen sized particles. The adhesive can be applied with a tape carrier of a white spun lace polyester/rayon blend. The adhesive being applied on both sides of the carrier and of a type, for example, sold by 3M as medical non-woven tape #9917. It was found that the relative adhesion of this adhesive to the skin increases over time and can double over a period of four hours from its initial application to counteract perspiration and skin oils generated during an 8 hour period of use. Thus, the ability to peel the facial mask off of the user after use is of value.

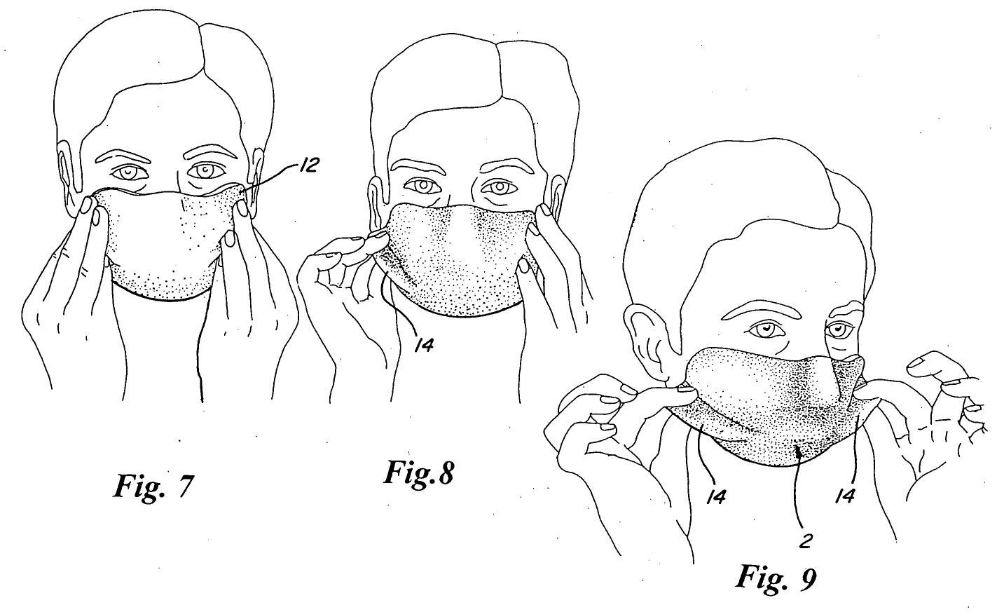

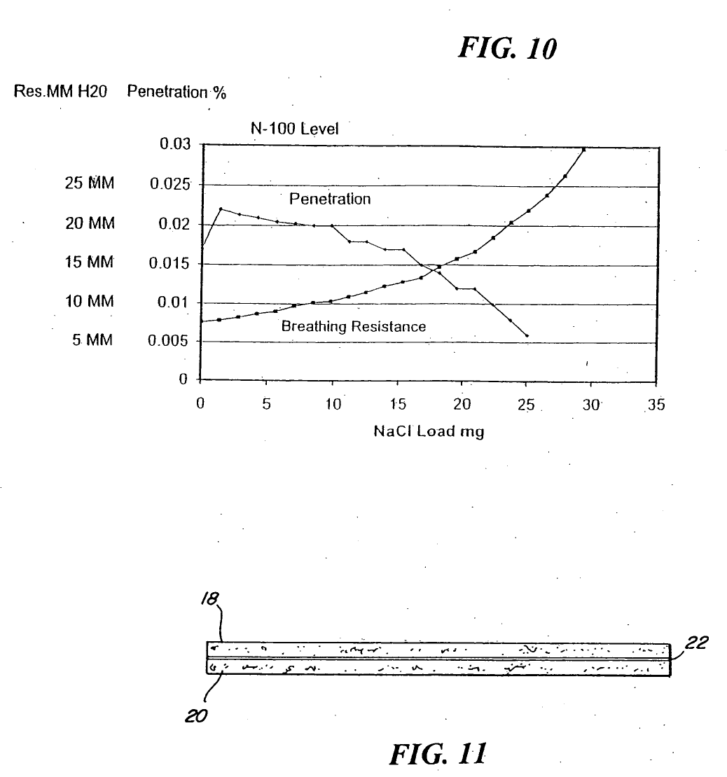

Referring to FIG. 7, a salt aerosol particle penetration test of a facial mask shown in FIG. 1 is shown. The results of this test indicate a performance better than an N-100 level certification of NIOSH requirements that is less than 0.03% penetration of 0.3 micron size salt particles in an aerosol at a flow rate of 85 L/min and further having a low breathing resistance of less than 11 mm H₂O. As can be determined, increasing the amount of salt load lowers the particle penetration while increasing the breathing resistance.

A large percentage of prior art facial masks establish a face seal by using flexible bands (rubber) to pull the respirator mask against the regular facial contours. Frequently the mask is pre-molded into a cup shaped configuration and sold in that configuration. However, a respiratory facial mask is only as good as the seal to the user's face, since penetration of undesirable particulate material can occur through the seal to the face. Additionally, the respiratory mask must not only filter the inhalation breathing of the user, but also can inhibit the path of the exhaust breath. When a positive pressure is developed within the mask, it can also leak air around the sides of the mask. If the purpose of the mask is to isolate a user or patient from spreading germs, the respiratory facial mask then is attempting to filter the breath of a user. A cough can significantly increase the pressure within the mask and germs can escape around the circumferential face seal interface of the mask and the user's face. The actions of the user such as talking and facial or body movements can also disrupt any seal between the face and the mask.

Frequently, conventional facial masks will have a one-way valve or check valve on a side of the facial mask to lower the exhalation resistance to the user and dissipate heat buildup in the facial mask. Such a valve may permit an infected user with a virus to spread the virus to other people. Additionally, the valve itself may be a source of penetration since by necessity they are of a relatively low cost, and simple mechanical design. It is not uncommon to have over 10% total inward leakage in CDC/NIOSH certified N-95, N-99 and N-100 type masks. NIOSH engages in research programs recognizing these limitations in the present respiratory facial mask technologies.

There is a current concern about the protection of healthcare workers, occupational employees and the general population in the event of a major disease outbreak or pandemic such as H5n1 avian influenza or SARS. Vaccines and effective anti-viral medicines are presently not available and the ability to provide a new vaccine production that would address a major outbreak is limited.

Economics plays a factor in that a facial mask must not only be people friendly, but relatively inexpensive while addressing the serious face seal leakage problems wherein a pathogen can bypass the filtration material and enter through small face sealed gaps directly into the nose and mouth of the user.

Disposable respiratory facial masks are necessary to protect workers and professionals in occupational as well as medical/dental activities from airborne viral and bacteria pathogens and aerosol contaminants and in many instances, are mandatory by OSHA and NIOSH government regulations under 42 CFR Part 84. A Portacount fit tester (TSI Corp.) has been accepted by OSHA to measure the effectiveness of a facial mask. The Portacount fit tester samples a range of particles of ambient air and compares the number of ambient air particles to the particles found inside the mask from face seal leakage as well as those particles that manage to penetrate the filter material on inhalation to establish a fit testing number for a surrogate mask. A 100:1 ratio is a minimum requirement by OSHA to pass the fit test. This test, however, only represents a benchmark and tests have shown that after a few minutes of inhalation, a masked user can inhale an infectious dose of influenza virus size particles if an infected person sneezes nearby. Thus, there is a critical need to substantially lower the risk factor of adverse health effects.

The use of surrogate masks in occupational settings is expensive and outmoded, since there is no guarantee that a size selection of an actual mask used offers the exact same fit and protection to an individual worker's face. There is also a need to provide a mask that would permit the general population to easily don and subjectively fit it to provide a substantial seal to the user's face. Needless to say, it would be highly desirable to do away with exhalation valves in the facial mask, which can spread disease if the user is infected and sneezes or coughs.

The ability to provide a universal size to fit most face types and the capabilities to subjectively mold the facial masks to enable almost zero face seal leakage, is a goal of the present invention. The ability to provide a HEPA level of particle penetration below 0.03% at 85 LPM at 0.3 microns, (which is a NIOSH requirement for N-100 certification) is an additional goal achieved in the present invention as shown in FIG. 7.

A recognized industrial standard for measuring the effectiveness of a facial mask on a user is the Portacount Overall Fit Factor testing procedure. Human subjects are put through a series of exercises meant to increase breathing rates and to dislodge the fit of the mask to simulate workplace exertions.

The final Overall Portacount Fit Factor number then averages and compares the concentration of particles from total inward leakage including face-to-mask seal as well as effectiveness of filtration media against the ambient air concentrations of particles over a wide range of particle sizes.

The present invention was measured for a large 9 inch length and a small 7 inch length facial mask on two subjects, A and B.

Average (for subjects A & B)

| Mask | Action 1 | Action 2 | Action 3 | Action 4 | Action 5 | Action 7 | Action 8 | Overall FF |
|---|---|---|---|---|---|---|---|---|
| Facial mask (large, 5/8″) | 878 | 886 | 1230 | 903 | 192 | 510 | 733 | 483 |
| SD | 625 | 382 | 913 | 546 | 99 | 283 | 314 | ±243 |
| Facial mask (small, 5/8″) | 1605 | 627 | 2993 | 1125 | 359 | 745 | 1129 | 730 |
| SD | 2084 | 511 | 3222 | 982 | 244 | 664 | 1119 | ±594 |

Action
1Normal Breathing
2Deep Breathing
3Head side to side
4Head up and Down
5Talking
6Grimace (excluded)
7Bending over
8Normal Breathing

$Overall Fit Factor = \frac{Number of exercises}{{ff}_{1}^{- 1} + {ff}_{2}^{- 1} + {ff}_{3}^{- 1} … + {ff}_{i}^{- 1}}$

All overall fit factors obtained for both facial masks (total of 11 replicates) significantly exceeded the threshold of 100 (FFₒᵥₑᵣₐₗₗ=175, 299, 465, 517, 558, and 881 for the large facial mask, and FFₒᵥₑᵣₐₗₗ=218, 245, 619, 904, and 1603 for the small facial mask). Almost every action-specific fit factor obtained for both facial masks exceeded 100, although there is no minimum requirement for FF measured in specific exercise (only for the overall FF for a subject), the latter finding shows consistency of the human-subject-measured performance of both facial masks. No significant change between subjects A and B (t-test: p=0.15>0.05). No significant change between the large and small facial masks (t-test: p=0.08 0.05). SD represents a Standard Deviation taken into account an average of the number of replications of testing.

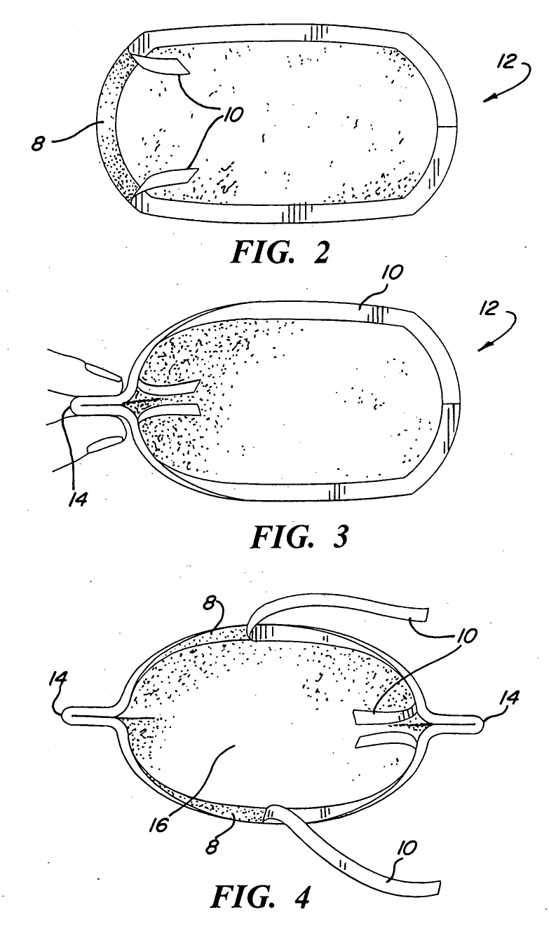

Referring to FIG. 2, a flat ovoid pre-form facial mask blank 12 is shown. The user partially removes or peels back the paper liner 10 to expose a portion of the adhesive tape 8. As shown in FIG. 2, the pre-form blank can be appropriately sized by pinching to form wings or tabs 14 that are subjectively sized to the face of the user while forming a central concavity. The tabs provide structural supports to maintain the size and stability of the central concavity while still providing a filtration area.

As can be determined, the paper liner 10 still covers a majority of the adhesive tape so that the pre-form mask will not stick to the face of the user. While FIG. 3 discloses only one side of the oval pre-form 12 being sized, a user can also remove a portion of the paper liner 10 adjacent the opposite side of the ovoid and simultaneously do an initial sizing to form the central concavity 16 with a pair of tabs. This procedure subjectively matches the contours of the user's face.

Thus, as seen in FIG. 7, the pre-form 12 with side portions of the paper liner removed can be initially bent in a sizing operation by the user to subjectively meet the contours of the user's face. FIG. 8 shows a pinching action to adhere the adhesive on the contours on one side to form a tab 14. In FIG. 8, a similar action can be performed on an opposite side in the initial fitting of the mask and formation of the concavity.

Referring to FIG. 4, the pair of tabs 14 have been formed in the initial fitting procedure by the user and the concavity 16 has been subjectively created with the tabs 14 providing a structural integrity to maintain the shape of the concavity offset from the nostrils and mouth. The tabs 14 further prevent a collapse of the concavity during any negative pressure with user inhalation.

As shown in FIG. 4, the rear or user face side of the pre-form mask blank that has now been created with a concavity, is disclosed and the user is then removing the remaining portions of the paper liner that is covering the adhesive tape 8 to prepare for sealing to the face.

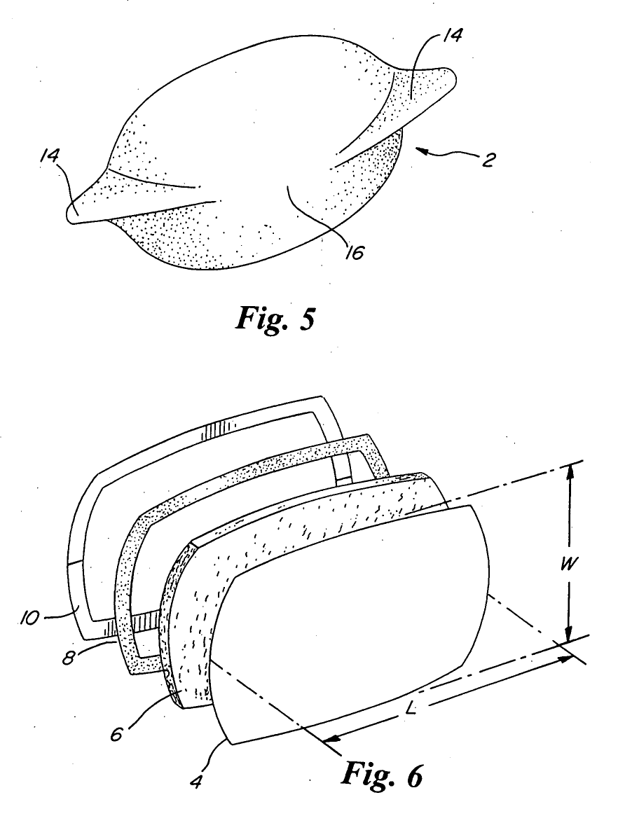

The user then fits the facial mask 2 as shown in FIGS. 5 and 9, with the adhesive tape 8 exposed to adhere to the contours of the user's face. Additional minor adjustments to the shape of the tabs can be part of the final fitting and subjective adjustment of the mask 2 to the user's face. The user should carefully exert a pressure commensurate with the 5/8″ width of adhesive tape 8 around the entire remaining perimeter of the facial mask 2 to ensure a complete adhesion to seal against the face.

As seen in FIG. 1, a substantial area to permit the exhausting and inhalation of air is still provided including air passing through portions of the tabs 14. Thus, the facial mask 2 of the present invention is both efficiently sized to the individual's face while assuring a sealing of the perimeter of the mask about the nostrils and mouth of the user to prevent edge leakage. Additionally, an exhaust valve is not required to be included in the structure of the mask while still enabling a relatively low inhalation pressure resistance, for example in the larger mask of the 9 inch length size of less than 11 mm H₂O and on the 7 inch length size a breathing resistance of approximately 14.5 mm H₂O.

The larger facial mask more than adequately meets the N-100 certification and a HEPA performance requirement. It also far exceeds the Portacount Human Subject Fit Factors by a factor of 4 or more over the industry standard. The larger size facial mask has a 0.3 micron particle penetration of less than 0.03% at 85 L/min. The viral filtration efficiency (VFE) is greater than 99.9% while the bacterial filtration efficiency (BFE) is greater than 99.9%. The smaller facial mask with a 7 inch length can meet N-99 certification standards with a 0.3 micron particle penetration of less than 0.17% at 85 L/min, a breathing resistance of 14.5 mm H₂O, a VFE of greater than 99.9% and a BFE greater than 99.9%.

Finally, the smaller facial mask size still has a high Portacount Human Subject Fit Factor exceeding 200.

Because of the subjective sizing capacity of the pre-form mask blank, a relatively quick and subjective fitting can be accomplished with a minimal set of instructions or training for the user. The facial mask of the present invention has, for the 9 inch length, a cooling evaporation of breath water vapor at 580 Cal. gram on inhalation wherein the trapped water vapor from the exhaust breath can cool the interior of the mask by approximately 15° F.

The present pinch system for forming the tabs 14 creates a tenting effect in forming the concavity that will subjectively match facial structures from a child to a large adult while offsetting the filter surface from the nostrils and mouth to increase the effective filtration area. The facial mask of the present invention can be applied usually in less than one minute.

While it is contemplated that the pre-form mask blanks 12 will be sold in a flat configuration to maximize the subjective fitting to the user, it is also possible to have the pre-form mask blanks 12 sold with preliminary initial tabs 14 and a concave configuration, as shown in FIG. 5 with a user further adjusting the tabs 14 for sizing when applying the facial mask.

The preferred form of the invention, however, is to provide the maximum options to the user in directly applying the pre-form mask blanks 12 as disclosed in FIGS. 2-4 and 7-9.

Basically, the user pinches the sides of the pre-form filter in the initial sizing step to create the structural support concavity 16 with the side tabs 14, then removes the remaining paper liners 10 and carefully finalizes the pinching of the tabs 14 along with a gentle pressure along the perimeter of the facial mask to ensure a full sealing of the facial mask to the face of the user. The adhesive selected has a capacity to further flow and set up on the face during use to increase the sealing force. When removing a spent facial mask 2, the respective tabs 14 provide convenient grasping handles to gently peel the facial mask from the face of the user.

A further modification of the present invention includes adding a flexible layer of activated carbon and an appropriate support medium that is porous to air flow can be laminated intermediate in the second layer 6 of fiber media. The fiber media layer 6 can advantageously be formed with a pair of sub-layers 18 and 20 that are united together to form the second layer 6 of fiber media. The improvement embodiment comprises laminating a thin intermediate activated carbon layer 22 between layers 18 and 20. The carbon material has a capacity of trapping and removing odors and, to a degree, smoke, as an additional filtration feature of an alternative embodiment of the present invention.

A cross section of the modified second layer 6 of fiber media is shown in FIG. 11. The same procedures for sizing and fitting a pre-form mask blank containing a thin carbon layer can likewise be used as described above.

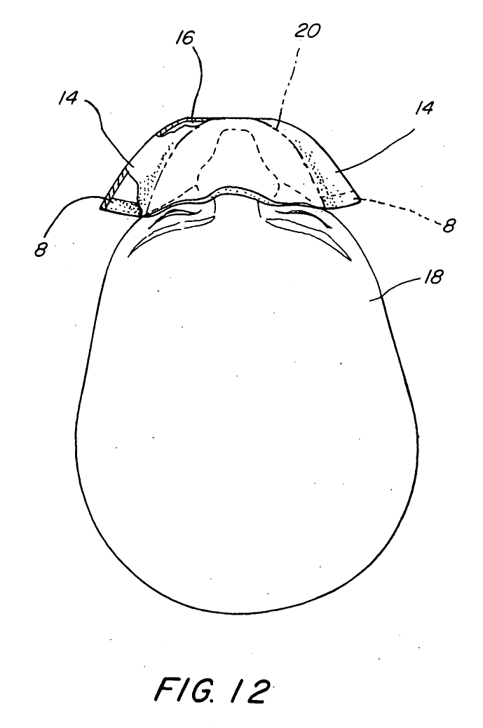

FIG. 12 discloses a schematic illustrative example of the increased filtration area available as a result of the wings or tabs 14 formed during a sizing operation of the facial mask. A conventional cup shape facial mask 20 is disclosed across the user's 18 nose and extends down below the mouth. By comparison, the facial mask 2 of the present invention provides the same filtration area as the conventional mask plus increased filtration by approximately 56.5 cm² as a result of the creation of the tabs or wings 14. The adhesive 8 that is joined together to form the structural tabs or wings 14 provide the additional filtration area to lower the exhalation and inhalation resistance for the user 18. Additionally, the added surface area substantially decreases the total overall media velocity and increases the particle resident time to further lower the penetration of particles through the filter material.

In summary, a highly efficient and essentially leak-resistant mask structure that can be easily fitted in a subjective manner to the user's face is provided. Thus, an economical, superior performance product is now made available to meet the increasing demands of both industrial and medical applications.

Those skilled in the art will appreciate that various adaptations and modifications of the just-described preferred embodiment can be configured without departing from the scope and spirit of the invention. Therefore, it is to be understood that, within the scope of the amended claims, the invention may be practiced other than as specifically described herein.

What is claimed is:

1. A method of customizing a respiratory facial mask to seal on a user's face comprising the steps of:
providing a flat flexible filter member with a perimeter of an adhesive member;
pressing opposite edges of the filter member to cause selected portions of the perimeter adhesive member to adhere together to form a central concavity in the filter member of a size to cover the user's mouth and nostrils; and
attaching the remaining portion of the exposed perimeter adhesion member directly to the user's face to sealingly encircle the nostrils and mouth of the user.

2. The method of claim 1 wherein the step of pressing selected portions of the perimeter adhesion member together forms tabs extending outward from opposite sides of the central concavity to support the central concavity shape and which can further assist in removal of the respiratory facial mask.

3. The method of claim 2 wherein increasing the size of one or more of the tabs pulls the remaining portions of the perimeter adhesion member sealingly against the user's face.

4. A method of customizing a respiratory facial mask to seal on a user's face comprising the steps of:
providing an elongated flat flexible filter member with a pair of curvilinear opposite sides with an endless perimeter of an adhesion member;
initially pressing selected portions of the adhesion member on each of the curvilinear opposite sides to form a pair of tabs and a central concavity in the filter member of a size to cover the user's mouth and nostrils; and
attaching the central concavity of the filter member over the user's mouth and nostrils by pressing the remaining portions of the exposed perimeter adhesion member directly to the user's face including, if necessary, increasing the size of one or more of the tabs to provide a firm seal to the user's face while offsetting the filter member from the user's mouth and nostrils.

5. A respiratory facial mask comprising:
a flexible filter member of a size to extend over a mouth and nostrils of a user having a central concavity and a pair of tabs, formed from the flexible filter member, projecting outwardly from opposite sides of the central concavity; and
an adhesive band extending from each tab to encircle the central concavity for sealing with the user's face, wherein the central concavity can be fitted over the user's mouth and nostrils with the pair of tabs on lateral sides of the user's face and the adhesive band sealing attached to the user's face.

6. The respiratory facial mask of claim 5 wherein the flexible filter member includes a tribo-electric charged polypropylene/acrylic filter media layer.

7. The respiratory facial mask of claim 6 wherein the flexible filter member includes a melt blown glossy surface layer on an exterior of the polypropylene/acrylic filter media to impede accumulation of airborne particles.

8. The respiratory facial mask of claim 7 wherein the polypropylene/acrylic filter media layer has a weight of 300 grams/meter and ⅛ inch in thickness.

9. The respiratory facial mask of claim 8, wherein the facial mask has an ovoid shape with a length approximately twice the width to provide approximately 200 cm² of filtration area.

10. The respiratory facial mask of claim 9 wherein a medical grade hypoallergenic acrylate adhesive band is attached to the polypropylene/acrylic filter media layer.

11. The respiratory facial mask of claim 5 wherein the pair of tabs have an approximately triangular configuration.

12. The respiratory facial mask of claim 5 wherein an antimicrobial film is provided on an exterior surface of the filter member.

13. The respiratory facial mask of claim 5 further including an intermediate layer of carbon impregnated non-woven fibers.

14. The respiratory facial mask of claim 5 wherein a 0.3 micron particle penetrations of less than 0.03% at 85 L/min. is provided pursuant to NIOSH standards.

15. The respiratory facial mask of claim 5 wherein the flexible filter member has no openings for an exhaust valve.

16. The respiratory facial mask of claim 5 wherein a breathing resistance of 11 mm H₂O or less is provided.

17. The respiratory facial mask of claim 5 wherein the adhesive bond increases, by a factor of 2, an adhesion force to a user's face over a period of approximately 4 hours after application to the user's face.

18. The respiratory facial mask of claim 5 wherein the flexible filter member traps breathe water vapor to cool the mask by approximately 15° F.

19. A respiratory facial mask for filtering ambient air, comprising:
a flat flexible filter member of a size to extend over a mouth and nostrils of a user, the filter member operable to block particles of 50 nm size while providing 25 mm or less of exhalation pressure resistance; and
a hypoallergenic adhesive extending about a perimeter of the filter member and operable to seal with the user's skin to provide a central concavity of a size to be offset from and cover the user's mouth and nostrils.

20. The respiratory facial mask of claim 19 wherein the flexible filter member is a non-woven fiber material.

21. The respiratory facial mask of claim 20 wherein the flexible filter member has an ovoid perimeter configuration.

22. The respiratory facial mask of claim 19 wherein the flexible filter member includes three layers, wherein a first layer and a third layer comprises a tribo-charged mixed fiber, non-woven needled felt and an intermediate second layer comprises an activated carbon layer.

23. The respiratory facial mask of claim 22 wherein the second layer includes activated carbon particles in a flexible carrier matrix.

24. The respiratory facial mask of claim 23 wherein the first and third layer includes a mixed fiber of polypropylene/acrylic and a surface film of an antimicrobial on the filter member.

25. The respiratory facial mask of claim 19 wherein the facial mask has a length approximately twice the width to provide approximately 200 cm² of filtration area.
